(19) United States
(12) Patent Application Publication
(10) Pub. No.: US 2026/0238388 A1
(43) Pub. Date: Aug. 13, 2026

(54) RETRANSMISSION SIZE BASED ON MUTUAL INFORMATION LOSS METRIC

(71) Applicant: QUALCOMM Incorporated, San Diego, CA (US)

(72) Inventors: Ronen SHAKED, Kfar Saba (IL); Jing JIANG, San Diego, CA (US); Mostafa KHOSHNEVISAN, San Diego, CA (US); Jing SUN, San Diego, CA (US); Gideon Shlomo KUTZ, Ramat Hasharon (IL); Amit BAR-OR TILLINGER, Tel-Aviv (IL)

(21) Appl. No.: 19/048,279

(22) Filed: Feb. 7, 2025

(51) Int. Cl. H04L 1/1809; H04B 17/309; H04B 17/382; H04W 72/542

(52) U.S. Cl. CPC H04L 1/1809; H04B 17/347; H04B 17/382; H04W 72/542

(57) ABSTRACT

Various aspects of the present disclosure generally relate to wireless communication. In some aspects, a network node may receive a first indication of a mutual information (MI) loss metric that is specific to a user equipment (UE). The network node may transmit a second indication of a retransmission size that is based at least in part on the MI loss metric. Numerous other aspects are described.

### FIELD OF THE DISCLOSURE

Aspects of the present disclosure generally relate to wireless communication and specifically relate to techniques, apparatuses, and methods associated with a retransmission size that is based on a mutual information loss metric.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A protocol stack may implement a hybrid automatic repeat request (HARQ) protocol to provide a retransmission mechanism between a transmitter and a receiver that enables the receiver to recover and/or correct data errors. One example of HARQ protocol may include a HARQ protocol that is based at least in part on a multi-incremental redundancy scheme (MIRS). To illustrate, a MIRS-based HARQ procedure may initially use an overestimated modulation and coding scheme (MCS) to reduce a likelihood of throughput loss that is based at least in part on an underestimated code rate. The MIRS-based HARQ procedure may rely on usage of small-sized retransmissions (e.g., a retransmission that has a first size that is smaller than a second size of an initial transmission that is associated with the retransmission) that include information that enables fine and/or dynamic adaptation of a coding rate based at least in part on the receiver feedback. As one example, each time the receiver transmits a negative acknowledgment (NACK), the transmitter may transmit, as the retransmission, a small quantity of additional redundancy bits (e.g., a smaller quantity relative to the initial transmission).

A receiver, such as a user equipment (UE), may use soft information, in the form of a log-likelihood ratio (LLR), to decode and recover bits that are transmitted through a wireless channel. Instead of a demodulator making a hard determination of a “1” bit value or a “0” bit value, the demodulator may generate an LLR that is a logarithm of a ratio of the probabilities that a bit is “1” or “0”. The soft information is then input to a channel decoder that may iteratively process the soft information to update the probability of whether a bit is “1” or “0”, which may mitigate potential bit errors and may decrease recovery errors.

### SUMMARY

Some aspects described herein relate to a method of wireless communication performed by a network node. The method may include receiving a first indication of a mutual information (MI) loss metric that is specific to a user equipment (UE). The method may include transmitting a second indication of a retransmission size that is based at least in part on the MI loss metric.

Some aspects described herein relate to a method of wireless communication performed by a UE. The method may include transmitting a first indication of an MI loss metric that is specific to the UE. The method may include receiving a second indication of a retransmission size that is based at least in part on the MI loss metric.

Some aspects described herein relate to a network node. The network node may include a processing system. The processing system may include one or more processors and one or more code-storing memories coupled with the one or more processors. The processing system may be configured to cause the network node to receive a first indication of an MI loss metric that is specific to a UE. The processing system may be configured to cause the network node to transmit a second indication of a retransmission size that is based at least in part on the MI loss metric.

Some aspects described herein relate to a UE. The UE may include a processing system. The processing system may include one or more processors and one or more code-storing memories coupled with the one or more processors. The processing system may be configured to cause the UE to transmit a first indication of an MI loss metric that is specific to the UE. The processing system may be configured to cause the UE to receive a second indication of a retransmission size that is based at least in part on the MI loss metric.

Some aspects described herein relate to a non-transitory computer-readable medium that stores a set of instructions for wireless communication by a network node. The set of instructions, when executed by one or more processors of the network node, may cause the network node to receive a first indication of an MI loss metric that is specific to a UE. The set of instructions, when executed by one or more processors of the network node, may cause the network node to transmit a second indication of a retransmission size that is based at least in part on the MI loss metric.

Some aspects described herein relate to a non-transitory computer-readable medium that stores a set of instructions for wireless communication by a UE. The set of instructions, when executed by one or more processors of the UE, may cause the UE to transmit a first indication of an MI loss metric that is specific to the UE. The set of instructions, when executed by one or more processors of the UE, may cause the UE to receive a second indication of a retransmission size that is based at least in part on the MI loss metric.

Some aspects described herein relate to an apparatus for wireless communication. The apparatus may include means for receiving a first indication of an MI loss metric that is specific to a UE. The apparatus may include means for transmitting a second indication of a retransmission size that is based at least in part on the MI loss metric.

Some aspects described herein relate to an apparatus for wireless communication. The apparatus may include means for transmitting a first indication of an MI loss metric that is specific to the UE. The apparatus may include means for receiving a second indication of a retransmission size that is based at least in part on the MI loss metric.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of a hybrid automatic repeat request (HARQ) process.

FIG. 4 is a diagram illustrating a first example and a second example of multi-incremental redundancy scheme communications.

FIG. 5 is a diagram illustrating an example graph that charts variations in data throughput based at least in part on a channel condition, a log-likelihood ratio compression level, and a HARQ scheme.

FIG. 6 is a diagram illustrating an example table that maps an mutual information loss metric to a retransmission size.

FIG. 7 is a diagram illustrating an example of a wireless communication process between a network node and a user equipment (UE).

FIG. 8 is a diagram illustrating an example process performed, for example, at a network node or an apparatus of a network node.

FIG. 9 is a diagram illustrating an example process performed, for example, at a UE or an apparatus of a UE.

FIG. 10 is a diagram of an example apparatus for wireless communication.

FIG. 11 is a diagram of an example apparatus for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A protocol stack may implement a hybrid automatic repeat request (HARQ) protocol to provide a retransmission mechanism between a transmitter and a receiver that enables the receiver to recover and/or correct data errors. One example of HARQ protocol may include a HARQ protocol that is based at least in part on a multi-incremental redundancy scheme (MIRS). To illustrate, a MIRS-based HARQ procedure may initially use an overestimated modulation and coding scheme (MCS) to reduce a likelihood of throughput loss that is based at least in part on an underestimated code rate. The MIRS-based HARQ procedure may rely on usage of small-sized retransmissions (e.g., a retransmission that has a first size that is smaller than a second size of an initial transmission that is associated with the retransmission) that include information that enables fine and/or dynamic adaptation of a coding rate based at least in part on the receiver feedback. As one example, each time the receiver transmits a negative acknowledgment (NACK), the transmitter may transmit, as the retransmission, a small quantity of additional redundancy bits (e.g., a smaller quantity relative to the initial transmission).

A receiver, such as a user equipment (UE), may use soft information, in the form of a log-likelihood ratio (LLR), to decode and recover bits that are transmitted through a wireless channel. Instead of a demodulator making a hard determination of a “1” bit value or a “0” bit value, the demodulator may generate an LLR that is a logarithm of a ratio of the probabilities that a bit is “1” or “0”. The soft information is then input to a channel decoder that may iteratively process the soft information to update the probability of whether a bit is “1” or “0”, which may mitigate potential bit errors and may decrease recovery errors.

In a MIRS-based HARQ procedure, the UE may store LLRs generated from a transmission that the UE fails to successfully decode, and may use the additional information received in a retransmission in combination with the stored LLRs to reattempt decoding the transmission. Relative to other receivers, the UE may have reduced storage capacity such that storing the LLRs for a MIRS-based HARQ procedure may occupy a large portion of the storage, resulting in less storage for other tasks and processes. Accordingly, the UE may use LLR compression to reduce an amount of data that is stored at the UE. “LLR compression” denotes a process in which a device stores an LLR value that has a reduced number of bits relative to a full-precision LLR, and “LLR compression level” denotes a configuration of the LLR compression (e.g., how many bits are retained and how many bits are discarded). LLR compression, as well as the variations in LLR compression levels used at a UE, may be UE-specific or device-specific insofar as each UE may implement an LLR compression scheme uniquely from other UEs, may implement the LLR compression scheme using a proprietary algorithm, or may autonomously switch to different LLR compression levels scheme without explicit implementation instructions being specified by a communication standard or a network node. To illustrate, the UE may independently select an LLR compression level based in internal metrics, such as any combination of a power level, available processing power, or available memory.

In some cases, a network node may select a size of an MIRS-based HARQ retransmission (e.g., a size of the additional parity bits) based at least in part on network node policies. As a first example, the network node may increase a size of a retransmission or may increase a quantity of parity bits returned as a retransmission to accelerate convergence of a failed codeblock. As a second example, the network node may increase the size of the retransmission or the quantity of parity bits based at least in part on a number or quantity of concurrent open HARQ processes satisfying a high threshold. Without knowledge of how a UE implements LLR compression, or what LLR compression level the UE uses, a network node may select a sub-optimal MCS, a sub-optimal retransmission size, a sub-optimal quantity of parity bits, or a combination thereof, for an MIRS-based HARQ procedure. Selecting a sub-optimal MCS, a sub-optimal retransmission size, or a sub-optimal quantity of parity bits may lead to extending a retransmission procedure, may increase data transfer latency, may reduce a spectral efficiency, or may reduce a data throughput.

Various aspects relate generally to a retransmission size based at least in part on a mutual information loss metric. Some aspects more specifically relate to a UE indicating a metric that indicates a current LLR compression at the UE to a network node, enabling the network node to select an optimal retransmission size. In some aspects, a network node may receive a first indication of a mutual information (MI) loss metric that is specific to UE. The network node may transmit a second indication of a retransmission size that is based at least in part on the MI loss metric. An MI loss metric may quantify a first amount of LLR information that is retained by the UE, may indicate a second amount of LLR information lost (e.g., by LLR compression), or a combination of the two.

In some aspects, a UE may transmit a first indication of an MI loss metric that is specific to the UE. Alternatively, or additionally, the UE may receive a second indication of a retransmission size that is based at least in part on the MI loss metric. In some aspects, the retransmission size may be based at least in part on a quantity of parity bits included in a retransmission for an MIRS-based HARQ process.

Particular aspects of the subject matter described in this disclosure can be implemented to realize one or more of the following potential advantages. In some examples, by a UE transmitting, and a network node receiving, an MI loss metric, the described techniques can be used to enable the UE to provide UE-specific information about LLR compression at the UE, and the network node to select a quantity of parity bits to return to the UE in an MIRS-based HARQ process. More particularly, an MI loss metric provides an indication of an LLR compression-decompression scheme in a universal, standardized, or generic manner such that the different UEs with different LLR compression algorithms, different LLR compression level switching algorithms, or a combination of the two may indicate a current status or current configuration of a respective LLR compression algorithm in a consistent and comparable manner. The network node may use the MI loss metric to select a retransmission size (e.g., a quantity of parity bits) that mitigates the UE requesting another retransmission and increases spectral efficiency. Mitigating the UE requesting another retransmission and increasing spectral efficiency may reduce a data transfer latency and increase data throughput in a wireless network.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

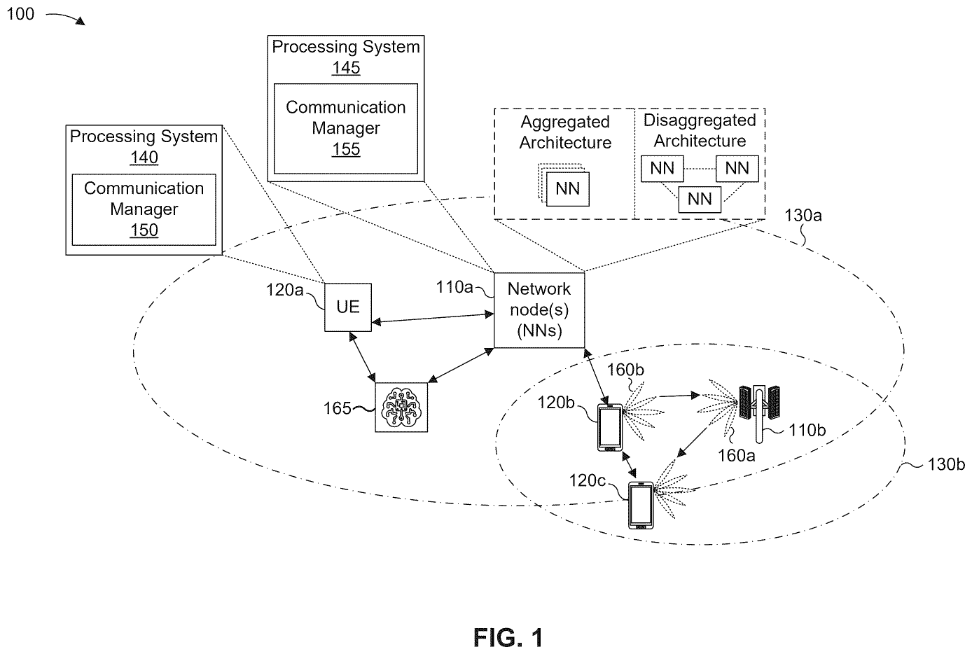

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

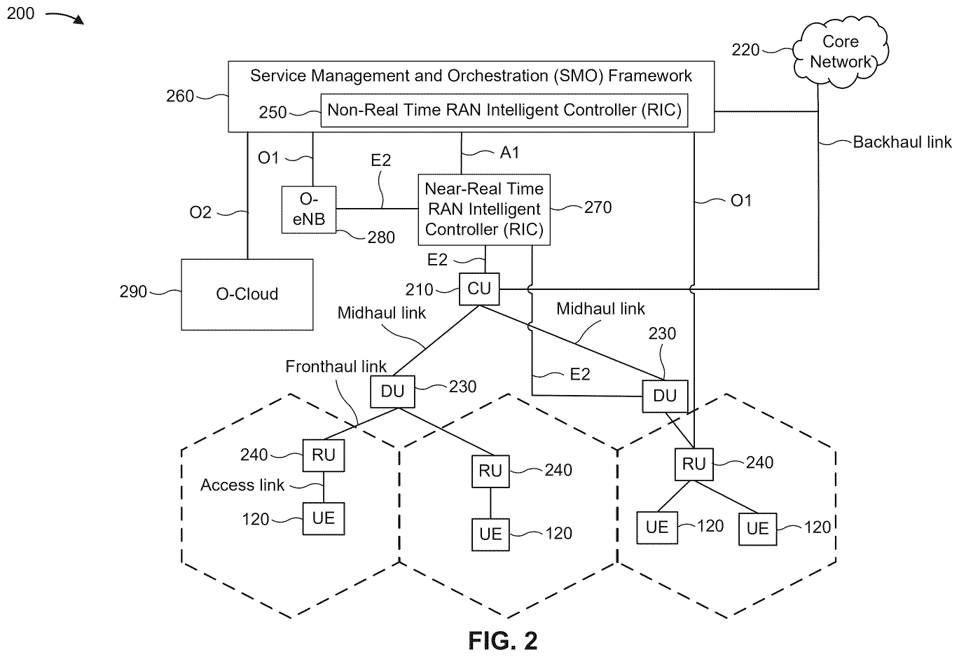

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/MVL model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a network node (e.g., a network node 110) may include a communication manager 155. As described in more detail elsewhere herein, the communication manager 155 may receive a first indication of an MI loss metric that is specific to a UE; and transmit a second indication of a retransmission size that is based at least in part on the MI loss metric. Additionally, or alternatively, the communication manager 155 may perform one or more other operations described herein.

In some aspects, a UE (e.g., a UE 120) may include a communication manager 150. As described in more detail elsewhere herein, the communication manager 150 may transmit a first indication of an MI loss metric that is specific to the UE; and receive a second indication of a retransmission size that is based at least in part on the MI loss metric. Additionally, or alternatively, the communication manager 150 may perform one or more other operations described herein.

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

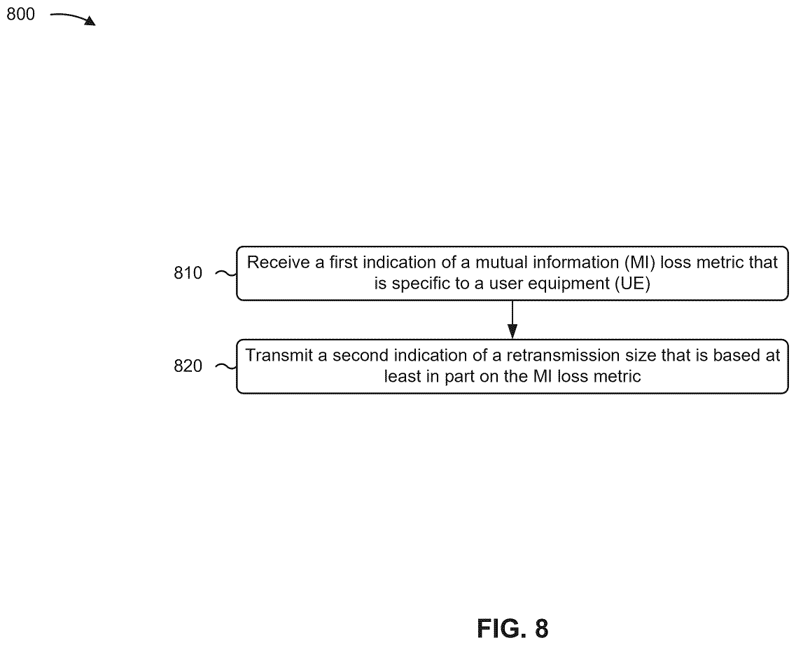

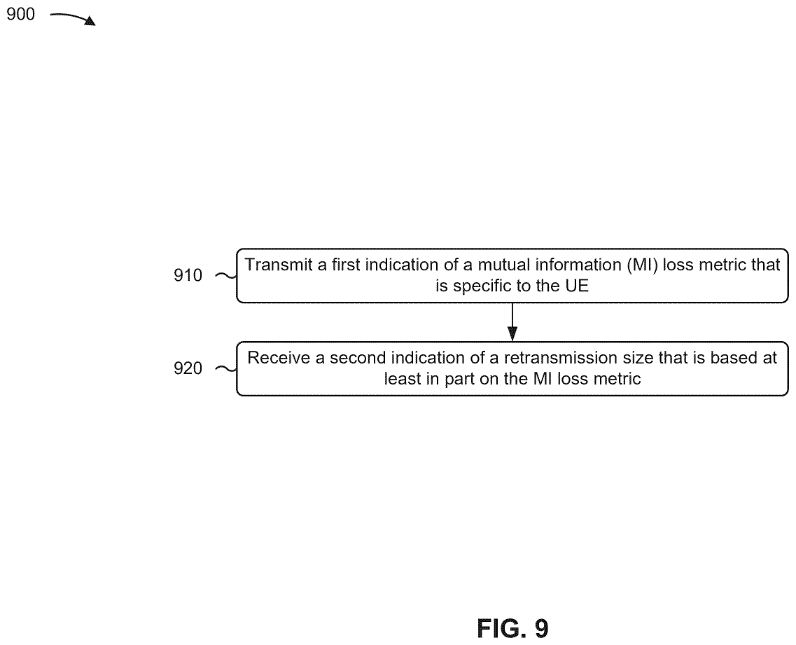

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a retransmission size that is based on a mutual information loss metric, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9X, or other processes as described herein. In some examples, executing instructions may include running the instructions, converting the instructions, compiling the instructions, and/or interpreting the instructions, among other examples.

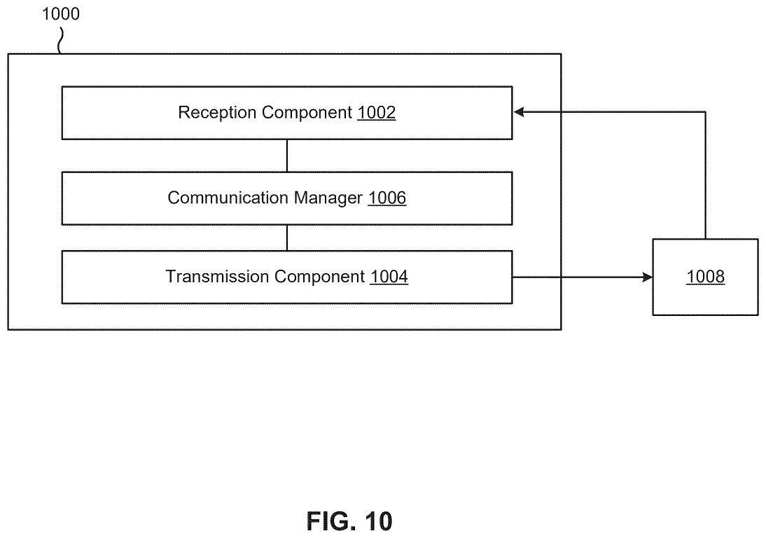

In some aspects, a network node (e.g., a network node 110) includes means for receiving a first indication of an MI loss metric that is specific to a UE; and/or means for transmitting a second indication of a retransmission size that is based at least in part on the MI loss metric. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

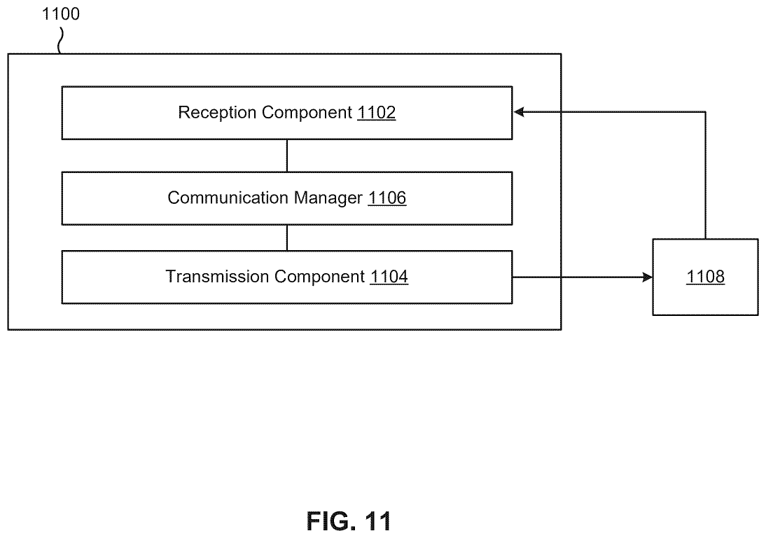

In some aspects, a UE (e.g., a UE 120) includes means for transmitting a first indication of an MI loss metric that is specific to the UE; and/or means for receiving a second indication of a retransmission size that is based at least in part on the MI loss metric. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other

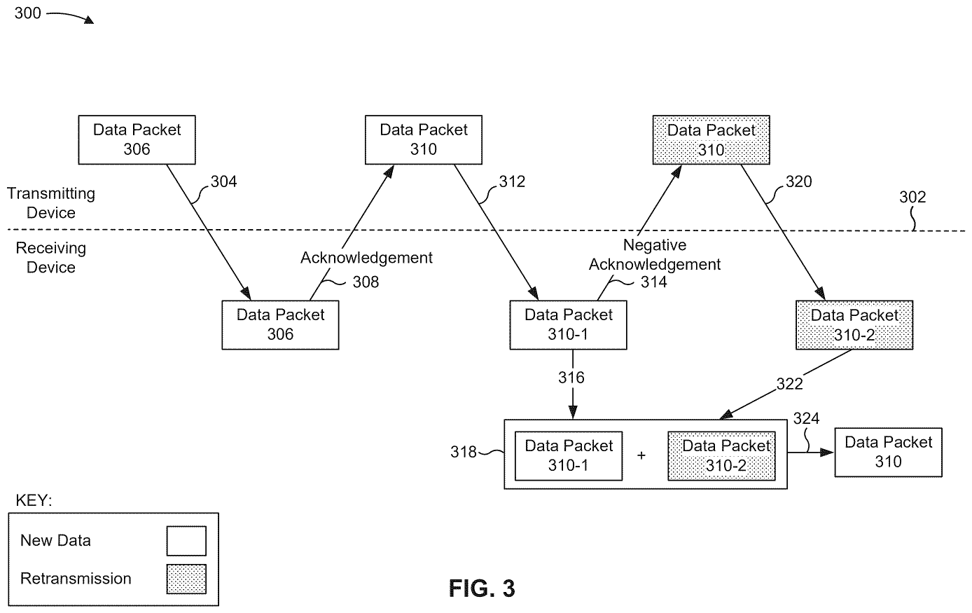

FIG. 3 is a diagram illustrating an example 300 of a HARQ process, in accordance with the present disclosure.

A MAC layer of a protocol stack may implement a HARQ protocol to provide a faster retransmission mechanism relative to other retransmission mechanisms, such as a radio link control (RLC) layer retransmission system. In some aspects, the HARQ protocol may include a transmitting device using a retransmission protocol in combination with a receiving device, such as a send and wait (SAW) protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device-receiving device pairs that may implement a HARQ process in combination may include a network node 110 and a UE 120 (e.g., a downlink HARQ process), a UE 120 and a network node 110 (e.g., an uplink HARQ process), and/or a first UE 120 and a second UE 120 (e.g., a sidelink HARQ process). Thus, a HARQ process may be used for downlink communications, uplink communications, and/or sidelink communications. In some aspects, and as part of a HARQ process, a network node may transmit information in downlink control information (DCI) that indicates to a receiving device (e.g., a UE 120) which downlink transmission(s) and/or which uplink transmissions to process using a HARQ protocol. Alternatively, or additionally, and as part of the HARQ process, a first UE may transmit information in sidelink control information (SCI) that indicates, to a second UE, which sidelink transmission(s) to process using the HARQ protocol.

In some aspects, a HARQ process and/or HARQ protocol may enable a receiving device to correct errors in a received data packet, such as by correcting errors within a TB based at least in part on soft combining packets in a physical (PHY) layer as described below. In some aspects, a TB may be partitioned into one or more code block groups (CBGs), and each CBG may partitioned into one or more code blocks (CBs). To correct for errors, the receiving device may buffer one or more data packets that have been identified as including an error, combine the data packets, and process the combined data packets to reduce errors. In some aspects, “codeword (CW)” may refer to a TB that includes error protection, and a transmission may include multiple CWs.

The example 300 includes transactions between a transmitting device and a receiving device. Transactions and/or data located above dashed line 302 are performed by, and/or reside at, a transmitting device (e.g., a network node 110 for a downlink HARQ process, a UE 120 for an uplink HARQ process, and/or a first UE 120 for a sidelink HARQ process). Transactions and/or data located below the dashed line 302 are performed by, and/or reside at, a receiving device (e.g., a UE 120 for a downlink HARQ process, a network node 110 for an uplink HARQ process, and/or a second UE 120 for a sidelink HARQ process). As shown by reference number 304, the transmitting device may transmit a first data packet 306 that is a new transmission of data that is included in the first data packet 306 (e.g., a first transmission of the data, shown through the use of solid white). In some aspects, the transmitting device may buffer and/or store the first data packet 306 as part of a HARQ process until receiving an indication from the receiving device that the first data packet 306 has been received and/or recovered with minimal errors (e.g., error-free and/or a number of errors that satisfy a low threshold). Based at least in part on receiving the first data packet 306 with minimal errors, the receiving device may transmit an ACK to the transmitting device as shown by reference number 308, such as a HARQ acknowledgement. The receiving device may validate the first data packet 306 using any suitable error detection mechanism, such as a cyclic redundancy check (CRC) process that validates the received data by computing a CRC value using the received data and comparing the computed CRC value(s) to a CRC value included with the received data.

Based at least in part receiving the ACK, the transmitting device may transmit a second data packet 310 as shown by reference number 312, and the second data packet 310 may be a new transmission of data (e.g., different data than the data included in the first data packet 306). In a similar manner as the first data packet 306, the transmitting device may store the second data packet 310 in the buffer and/or remove the first data packet 306 from the buffer. In some aspects, the receiving device may not receive the second data packet 310 successfully, shown in FIG. 3 as data packet 310-1. For example, the receiving device may identify that the data packet 310-1 was received with a number of errors that fail to satisfy the low error threshold. Accordingly, and as shown by reference number 314, the receiving device may transmit a NACK to indicate that the second data packet 310 was received with errors and/or unsuccessfully. Alternatively, or additionally, the receiving device may transmit the NACK to indicate a request for a retransmission of the second data packet 310. In some aspects, and as shown by reference number 316, the receiving device may store the data packet 310-1 in a buffer 318.

Based at least in part on receiving the NACK, and as shown by reference number 320, the transmitting device may retransmit the second data packet 310 to the receiving device, where the retransmission is shown by FIG. 3 through the use of a dotted pattern. The receiving device may receive the retransmission of the second data packet 310 (shown as data packet 310-2), and, as shown by reference number 322, the receiving device may store the data packet 310-2 in the buffer 318 and/or may combine the data packet 310-1 with the data packet 310-2. As one example, the receiving device may combine the data packet 310-1 and the data packet 310-2 prior to channel decoding and/or error detection, and may process the combined data packet to mitigate errors as shown by reference number 324. That is, by processing the combined data packet, the receiving device may recover data that includes minimal errors (e.g., is error-free and/or includes a number of errors that satisfy the low error threshold). In some aspects, the receiving may combine the data packet 310-1 and the data packet 310-2 using soft combining. “Soft combining” may denote combining multiple received signals based at least in part on a confidence and/or reliability of each received signal, such as by combining received signals using a log likelihood ratio (LLR), to improve a signal quality of the combined data packet and reduce recovery errors.

In some aspects, the receiving device may transmit an ACK to the transmitting device, such as in scenarios that the receiving device is able to recover a version of the second data packet 310 that includes minimal errors. In other aspects, the receiving device may transmit a NACK to the transmitting device, such as in scenarios that the receiving device is unable to recover a version of the second data packet 310 with minimal errors.

A HARQ process may be used to regulate any combination of PDSCH transmissions, PUSCH transmissions, and/or physical sidelink shared channel (PSSCH) transmissions. Accordingly, the first data packet 306 and/or the second data packet 310 shown by FIG. 3 may be based at least in part on one or more PDSCH transmissions, one or more PUSCH transmissions, and/or one or more PSSCH transmissions. For PDSCH transmissions, the receiving device (e.g., a UE 120) may transmit ACK/NACK feedback via PUCCH or PUSCH. For PUSCH transmission, the receiving device (e.g., a network node 110) may transmit ACK/NACK feedback in an uplink grant (e.g., indicated via downlink control information (DCI)). For a sidelink transmission, the receiving device (e.g., a UE 120) may transmit ACK/ACK feedback via a physical sidelink feedback channel (PSFCH).

As indicated above, FIG. 3 is provided as an example. Other examples may differ from what is described with regard to FIG. 3.

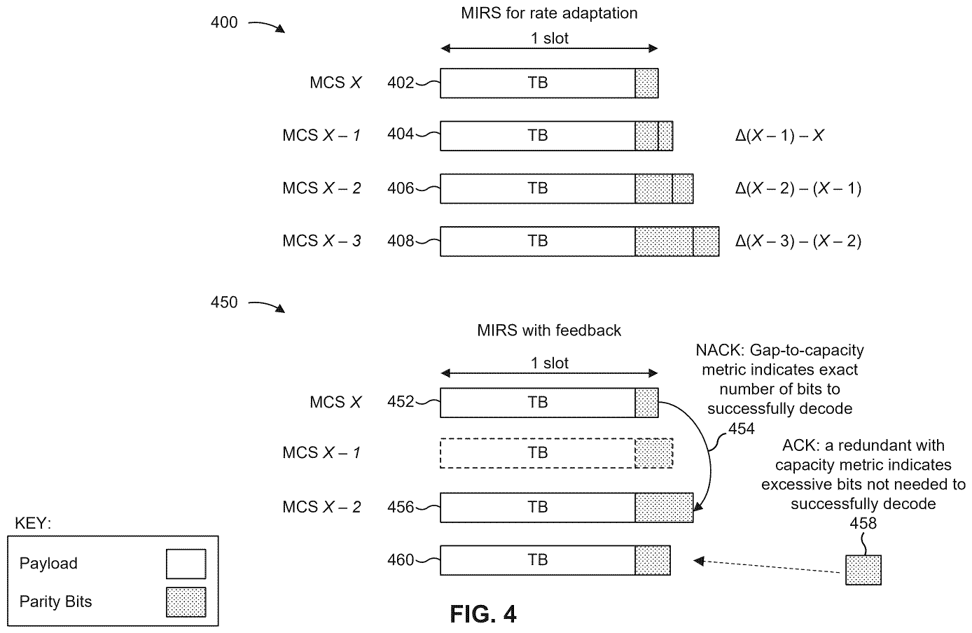

FIG. 4 is a diagram illustrating a first example 400 and a second example 450 of multi-incremental redundancy scheme (MIRS) communications.

Various communication systems may encode information onto a carrier signal for transmission over a communication channel based at least in part on an MCS. An MCS may specify a modulation type (e.g., 4-QAM, 16-QAM, 64-QAM, and/or 128-QAM) and/or a coding rate (e.g., a ratio of useful data bits to a total number of bits after error correction coding, such as 1/2 or 3/4). In some cases, the coding rate specified by an MCS may indirectly indicate a configuration (e.g., a quantity) of redundancy bits and/or error correction that are added to the transmitted data. To illustrate, a communication standard may specify a linkage between an MCS configuration and a coding rate.

Alternatively, or additionally, some communication systems may select an MCS configuration based at least in part on a CSI-RS metric to maximize data throughput with channel reliability (e.g., a channel capacity), which may also be referred to as a CSI-RS-based channel capacity operation. To illustrate, a CSI-RS metric may provide information about channel conditions (e.g., interference, signal quality, and/or fading characteristics), and a transmitter may select an MCS configuration that balances maximizing data throughput with channel reliability for the indicated channel conditions. In some cases, CSI-RS-based channel capacity operations may not be able to adapt to an instantaneous optimal MCS (e.g., the highest MCS that can be decoded successfully for a specific transmission time interval (TTI)). For example, a transmitter may select an MCS that, on average, balance maximizing data throughput with channel reliability for multiple TTIs. Accordingly, the selected MCS (e.g., an average MCS) may not be optimal for some TTIs over a duration, resulting in an MCS configuration that does not utilize an entirety of a channel capacity. Another factor that may reduce the efficacy of the CSI-RS-based channel capacity operations (e.g., how close to a theoretical channel capacity an MCS configuration that is selected based at least in part on a CSI-RS metric may achieve) is an accuracy of a CSI-RS estimation. For instance, a CSI-RS estimation may be error-prone and/or may not allow for accurate modeling (e.g., to within a threshold) of receiver performance. Alternatively, or additionally, a channel state may be sampled at discrete time(s) (e.g., at CSI-RS slots), rather than continuously over time, and the discrete sampling may fail to capture changes in the channel state, resulting in a sub-optimal MCS configuration between CSI-RS slots.

As part of CSI-RS channel capacity operations, a transmitter may select and/or set an MCS configuration (e.g., a modulation type and/or a coding rate configuration) in accordance with an initial transmission and may be unable to dynamically adapt the MCS configuration for future transmissions, such as a retransmission. In some cases, if the initial transmission fails, a retransmission may include a same number of coded bits (or approximately the same number of coded bits) as the initial transmission. Alternatively, or additionally, a transmitter may perform a retransmission operation based at least in part one or more redundancy versions (RVs) to select the bits that are included in the retransmission. As one example, the selected bits may be the same coded bits included in the initial transmission (e.g., using chase combining), which may result in the same code rate. As another example, the selected bits may be new coded bits (e.g., using incremental redundancy) that are not included in the initial transmission, which may result in reducing (e.g., halving) an effective coding rate in subsequent retransmissions. Accordingly, a coding rate that is selected for an initial transmission may be used as and/or impact a code rate of a retransmission. An overestimated coding rate may result in decoding errors that lead to throughput loss, and an underestimated coding rate may result in a loss of throughput based at least in part on transmitting a payload size that is reduced relative to a larger payload size that is supported for the same channel resource.

In some cases, link adaptation(s) between CSI-RS slots may be performed using an outer-loop link adaptation (OLLA) of a transmitter (e.g., a network node). To illustrate, a network node may adjust a target SNR and/or an MCS configuration based at least in part on an average of the feedback that is received over time, and the adjustments made based at least in on an average of the feedback may fail to track the optimal MCS changes to within a degree of accuracy.

MIRS is a HARQ technique in which multiple levels of redundancy are incrementally transmitted to a receiver. As described below, MIRS may be used to reduce a gap between an average MCS selection and an optimal MCS selection in a manner that enables communications to use a coding rate that is closer to a full capacity code rate relative to a coding rate that is based on the average MCS, regardless of device mobility. To illustrate, a MIRS-based HARQ operation may initially use an overestimated MCS to reduce a likelihood of throughput loss that is based at least in part on an underestimated code rate as described above. The MIRS-based HARQ operation may rely on usage of small-sized retransmissions (e.g., a retransmission that has a first size that is smaller than a second size of an initial transmission that is associated with the retransmission) that include information that enables fine and/or dynamic adaptation of a coding rate based at least in part on the receiver ACK or NACK feedback. As one example, each time the receiver transmits a NACK (or alternatively, does not transmit an ACK), the transmitter may transmit, as the retransmission, a small quantity of additional redundancy bits (e.g., a smaller quantity relative to the initial transmission). Optionally, the MIRS-based HARQ operation may use per-code-block (CB) feedback to maximize channel utilization.

An example MIRS-based HARQ operation may be performed in accordance with the following. For a first transmission (e.g., an initial transmission), the transmitter (e.g., a network node 110) may select an over-optimistic MCS. An over-optimistic MCS is an MCS that is expected to fail and/or result in recovery errors that satisfy an error threshold in many (e.g., most) cases. The selection of the over-optimistic MCS may determine one or more coding parameters, such as a coding rate and/or transport block size (TBS), for each of the subsequent retransmissions. For each decoding failure, a receiver (e.g., the UE 120) may send feedback with per-CB decoding results. Optionally, the receiver may convey additional information that enables the transmitter to perform a faster convergence towards an acceptable coding rate. For each decoding failure, the transmitter may schedule and transmit additional bits for each failing transport block (TB) and/or for each failing CB, and the additional bits may be from an initial coded bits buffer of the CBs. The additional bits in each retransmission may be used by a receiver to successfully recover bits that the receiver was previously unable to recover successfully and reduce an effective rate of each CB in small steps. In some cases, the process may repeat until all CBs (and consequently, the entire TB) are decoded successfully. A total number of bits transmitted over the first and subsequent transmissions may be used to configure a coding rate that is used for a future TB transmission.

To illustrate, in the first example 400, an initial transmission 402 by a transmitter may be based at least in part on a coding rate that is associated with and/or linked to an initial MCS X as described above. As shown by FIG. 4, the initial transmission 402 includes a TB (shown in solid white) and one or more coding bits (shown with a dotted pattern). Based at least in part on a receiver failing to decode the initial transmission 402 and sending feedback with per CB decoding results (e.g., as part of a HARQ process), the transmitter may schedule a second transmission 404 (e.g., a first retransmission) that adds one or more parity bits relative to the initial transmission 402, resulting in an effective coding rate that linked to an effective MCS configuration of MCS X−1. For example, the addition of the parity bits may reduce decoding errors (e.g., improve a decoding robustness) and/or reduce an effective coding rate by a factor that is equivalent to, effectively, an MCS configuration that is set to MCS X−1 (e.g., an effective MCS configuration). That is, the effective coding rate may be linked (e.g., via a communication standard) to an MCS configuration of MCS X−1, even though the actual MCS configuration is set to MCS X. Accordingly, “effective MCS configuration” denotes a behavior MCS configuration, rather than an actual MCS setting value.

Similarly, a third transmission 406, which is a second retransmission that is based at least in part on second feedback (e.g., that may include per CB decoding results associated with a failed decoding for the first retransmission), may include one or more additional parity bits relative to the first retransmission (e.g., the second transmission 404), resulting in an effective coding rate that is associated with an effective MCS configuration of MCS X−2. In a similar manner, the transmitter may transmit, based at least in part on third feedback from the receiver, a fourth transmission 408, which is a third retransmission that adds one or more parity bits relative to the initial transmission, the first retransmission, and the second retransmission, resulting in a further reduced effective coding rate that is associated with an effective MCS configuration of MCS X−3. A number and/or quantity of parity bits that are added to each retransmission may generally correspond to a difference (e.g., a delta) between the effective coding rate of the current retransmission and the effective coding rate of the previous retransmission, further shown by FIG. 4 as Δ(X−1)−X, Δ(X−2)−(X−1), and Δ(X−3)−(X−2).

The second example 450 depicts an example MIRS communication that uses a gap-to-capacity metric, a redundant with capacity metric, and/or other feedback to configure a number and/or a quantity of parity bits included in transmissions and/or retransmissions. For example, a transmitter may transmit an initial transmission 452 that includes a payload (shown in solid white) and a first set of parity bits (shown with a dotted pattern). A receiver may unsuccessfully decode at least some of the initial transmission and transmit NACK feedback. In some aspects, as shown by reference number 454, the NACK feedback may include and/or indicate information, such as a gap-to-capacity metric, that indicates a number and/or a quantity of parity bits to include in a subsequent retransmission to mitigate decoding errors and/or to ensure successful decoding of the subsequent retransmission. As one example, the information may indicate to change the MCS from a first MCS configuration (e.g., MCS X) to a second MCS configuration (e.g., MCS X-L, L having a value that is greater to or equal to 1 and indicating a missed channel capacity) for a subsequent retransmission. As shown by FIG. 4, the indication of the gap-to-capacity metric may reduce a number of retransmissions performed by the transmitter, such as by enabling the transmitter to omit a retransmission that is associated with an effective MCS configuration of MCS X−1 (shown with a dashed line) and instead transmit a first retransmission 456 that includes the indicated quantity of parity bits and results in an effective MCS configuration of MCS X−2.

Alternatively, or additionally, a receiver may transmit ACK feedback to indicate successful decoding. As shown by reference number 458, the ACK feedback may include information, such as a redundant-with-capacity metric, that indicates the excessive bits that were unnecessarily transmitted and/or not needed to successfully decode the data. Accordingly, a transmitter may transmit a second initial transmission 460 based at least in part on the ACK feedback, such as by increasing an MCS and/or or including fewer parity bits relative to the transmission associated with the ACK feedback.

A receiver, such as a UE, may use soft information, in the form of an LLR, to decode and recover bits that are transmitted through a wireless channel. Instead of a demodulator making a hard determination of a “1” bit value or a “0” bit value, the demodulator may generate an LLR that is a logarithm of a ratio of the probabilities that a bit is “1” or “0”. The soft information is then input to a channel decoder that may iteratively process the soft information to update the probability of whether a bit is “1” or “0”, which may mitigate potential bit errors and may decrease recovery errors.

In a MIRS-based HARQ retransmission process, the UE may store LLRs generated from a transmission that the UE fails to successfully decode, and may use the additional information received in a retransmission in combination with the stored LLRs to reattempt decoding the transmission. Relative to other receivers, the UE may have reduced storage capacity such that storing the LLRs for a MIRS-based HARQ retransmission process may occupy a large portion of the storage, resulting in less storage for other tasks and processes. Accordingly, the UE may use LLR compression to reduce an amount of data that is stored at the UE. “LLR compression” denotes a process in which a device (e.g., a UE or network node) stores an LLR value that has a reduced number of bits relative to a full-precision LLR, and “LLR compression level” denotes a configuration of the LLR compression (e.g., how many bits are retained and how many bits are discarded). LLR compression, as well as the variations in LLR compression levels, may be UE-specific or device-specific insofar as each UE may implement an LLR compression scheme uniquely from other UEs, may implement the LLR compression scheme using a proprietary algorithm, or may implement the LLR compression scheme without explicit implementation instructions being specified by a communication standard. In a similar manner, the UE may independently select an LLR compression level based in internal metrics, such as any combination of a power level, available processing power, or available memory.

As a first example, a UE may clip an LLR. To illustrate, a full-precision LLR may use eight bits, and a compressed LLR may be a quantized LLR that uses three bits or four bits. In such an example, the UE may store the three most significant bits (MSBs) of the eight-bit LLR may throw away the remaining five bits. The three retained MSBs may provide coarse magnitude and dominant information about the eight-bit LLR and the remaining five bits may provide finer precision and small refinements to the eight-bit LLR. In storing the three MSBs, the UE may reduce a storage size of the LLR while retaining information that impacts an LLR the most. A second example of LLR compression may include non-linear compand-ing techniques that retain critical LLR information, and a third example of LLR compression may include Max-Lloyd quantization.

In an MIRS-based HARQ system, the UE may request additional parity bits based at least in part on decoding errors, and a network node may respond with the additional parity bits that may be used by the UE to increase a precision of an LLR and, consequently, increase a likelihood of successful decoding. The use of MIRS-based HARQ may enable transmitter to achieve a higher data throughput relative to HARQ schemes that are based at least in part on a transmitter selecting an MCS that, on average, balances maximizing data throughput with channel reliability for multiple TTIs. For some operating scenarios, MIRS-based HARQ may reduce gap-to-capacity metric and approach an optimal MCS data throughput performance.

As indicated above, FIG. 4 is provided as an example. Other examples may differ from what is described with regard to FIG. 4.

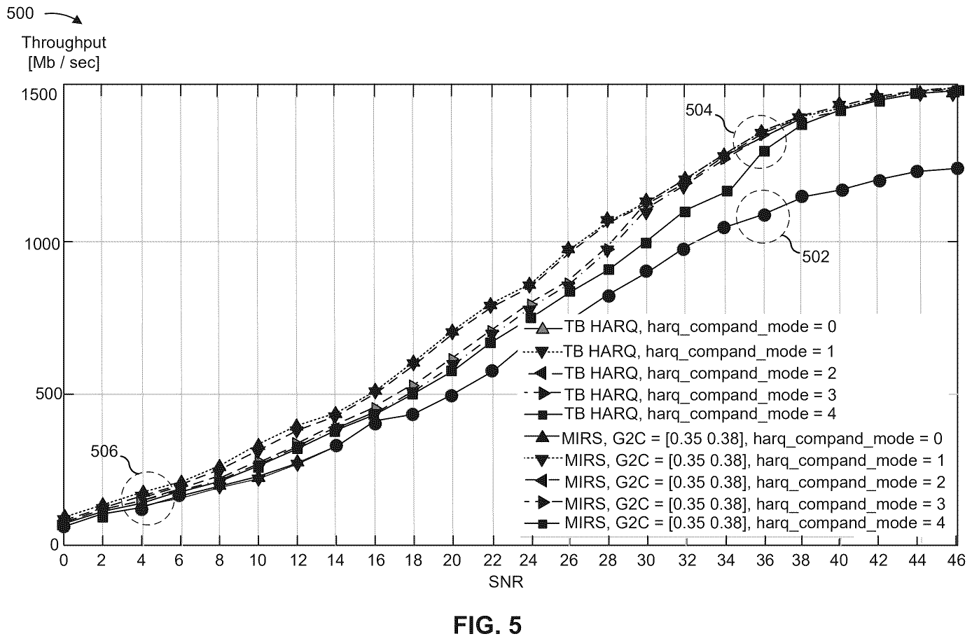

FIG. 5 is a diagram illustrating an example graph 500 that charts variations in data throughput based at least in part on a channel condition, an LLR compression level, and a HARQ scheme. A horizontal access of the graph 500 represents a channel condition that is characterized by a signal-to-noise ratio (SNR), and a vertical access of the graph 500 represents data throughput. The graph 500 includes multiple HARQ compand modes for a baseline HARQ scheme that operates at a transport block level without using MIRS (shown by FIG. 5 as TB HARQ) and multiple HARQ compand modes for a MIRS-based HARQ scheme (shown by FIG. 5 as MIRS). “HARQ compand” denotes a HARQ process in that uses compression (e.g., LLR compression) for storage and expansion (e.g., LLR expansion) for data recovery, and “HARQ compand mode” denotes a configuration used in the HARQ process, such as, among other things, an LLR compression level. A lower HARQ compand mode may be configured with a lower LLR compression level (e.g., the storage of more bits), and a higher HARQ compand monde may be configured with a higher LLR compression level (e.g., the storage of fewer bits). A first grouping of baseline HARQ scheme configurations are shown by reference number 502 and a second grouping of MIRS-based HARQ schemes are shown by reference number 504. As shown by graph 500, for higher SNR conditions, the MIRS-based HARQ may increase data throughput relative to the baseline HARQ in high SNR operating conditions, such as an of 36 decibels (dB) as shown by FIG. 5. In low SNR conditions, such as an SNR of 4 dB, the MIRS-based HARQ and the baseline HARQ may have commensurate performance and data throughput as shown by reference number 506. Accordingly, graph 500 indicates that the MIRS-based HARQ may be more aggressive in selecting a higher MCS in operating environments with high SNR relative to the baseline HARQ, and may be more sensitive to degradations in SNR relative to the baseline HARQ. Alternatively, or additionally, MIRS-based HARQ may tolerate higher LLR compression levels (e.g., fewer stored bits) in operating environments with high SNR relative to operating environments with low SNR.

In some cases, a network node may select a size of an MIRS-based HARQ retransmission (e.g., a size of the additional parity bits) based at least in part on network node policies. As a first example, the network node may increase a size of a retransmission or may increase a quantity of parity bits returned as a retransmission to accelerate convergence of a failed codeblock. As a second example, the network node may increase the size of the retransmission or the quantity of parity bits based at least in part on a number or quantity of concurrent open HARQ processes satisfying a high threshold. However, as described above, LLR compression and LLR compression level configurations may be UE-specific or device-specific, the UE may independently select an LLR compression level based in internal metrics, such as any combination of a power level, available processing power, or available memory. Without knowledge of how a UE implements LLR compression, or what LLR compression level the UE uses, a network node may select a sub-optimal MCS, a sub-optimal retransmission size, a sub-optimal quantity of parity bits, or a combination thereof, for an MIRS-based HARQ procedure. Selecting a sub-optimal MCS, a sub-optimal retransmission size, or a sub-optimal quantity of parity bits may lead to extending a retransmission procedure, may increase data transfer latency, may reduce a spectral efficiency, or may reduce a data throughput.

Various aspects relate generally to a retransmission size based at least in part on a mutual information loss metric. Some aspects more specifically relate to a UE indicating a metric that indicates a current LLR compression at the UE to a network node, enabling the network node to select an optimal retransmission size. In some aspects, a network node may receive a first indication of an MI loss metric that is specific to UE. The network node may transmit a second indication of a retransmission size that is based at least in part on the MI loss metric. An MI loss metric may quantify a first amount of LLR information that is retained by the UE, may indicate a second amount of LLR information lost (e.g., by LLR compression), or a combination of the two.

In some aspects, a UE may transmit a first indication of an MI loss metric that is specific to the UE. Alternatively, or additionally, the UE may receive a second indication of a retransmission size that is based at least in part on the MI loss metric. In some aspects, the retransmission size may be based at least in part on a quantity of parity bits included in a retransmission for an MIRS-based HARQ process.

Particular aspects of the subject matter described in this disclosure can be implemented to realize one or more of the following potential advantages. In some examples, by a UE transmitting, and a network node receiving, an MI loss metric, the described techniques can be used to enable the UE to provide UE-specific information about LLR compression at the UE, and the network node to select a quantity of parity bits to return to the UE in an MIRS-based HARQ process. More particularly, an MI loss metric provides an indication of an LLR compression-decompression scheme in a universal, standardized, or generic manner such that the different UEs with different LLR compression algorithms, different LLR compression level switching algorithms, or a combination of the two may indicate a current status or current configuration of a respective LLR compression algorithm in a consistent and comparable manner. The network node may use the MI loss metric to select a retransmission size (e.g., a quantity of parity bits) that mitigates the UE requesting another retransmission and increases spectral efficiency. Mitigating the UE requesting another retransmission and increasing spectral efficiency may reduce a data transfer latency and increase data throughput in a wireless network.

As indicated above, FIG. 5 is provided as an example. Other examples may differ from what is described with regard to FIG. 5.

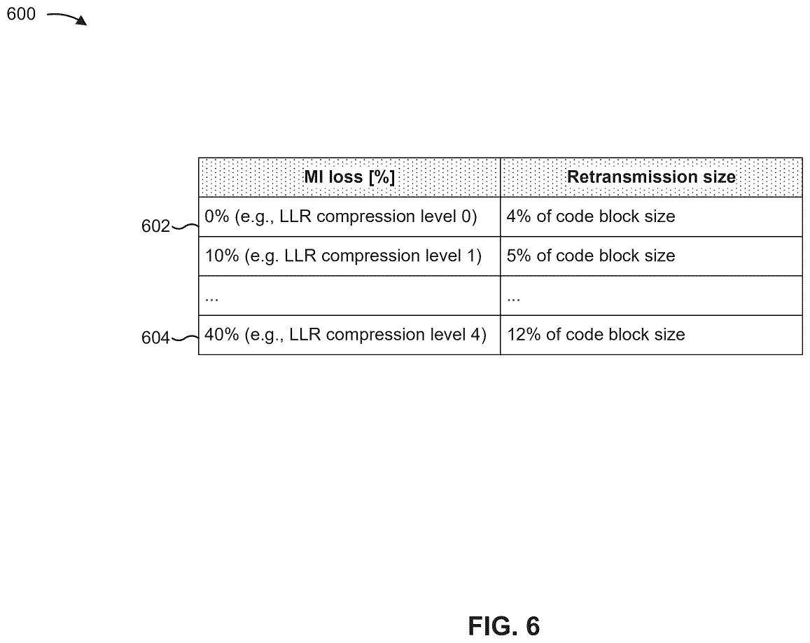

FIG. 6 is a diagram illustrating an example table 600 that maps an MI loss metric to a retransmission size.

UEs may implement UE-specific LLR compression algorithms that differently from one another. Alternatively, or additionally, each UE may autonomously switch between LLR compression levels in a different manner from one another. While the use of UE-specific compression algorithms may enable each UE to optimize performance of the LLR compressions to enhance system efficiency, the varying LLR compression algorithms and switching behaviors may result in inconsistent performance and, consequently, make selection of a retransmission size by a network node sub-optimal. An MI loss metric provides an indication of an LLR compression-decompression scheme in a universal, standardized, or generic manner such that the different UEs with different LLR compression algorithms, different LLR compression level switching algorithms, or a combination of the two may indicate a current status or current configuration of a respective LLR compression algorithm in a consistent and comparable manner.

In some aspects, a UE may measure an average MI that an LLR may carry for each LLR compression level or LLR compression mode supported by the UE. As an example, an LLR may be computed as:

$$LLR = log \frac{P ( Y \vert X = 0 )}{P ( Y \vert X = 1 )} \qquad ( 1 )$$

$$and$$

$$P ( Y \vert X = 0 ) = \frac{1}{1 + {e}^{LLR}} \qquad ( 2 )$$

$$P ( Y \vert X = 1 ) = \frac{{e}^{LLR}}{1 + {e}^{LLR}} \qquad ( 3 )$$

where X represents a transmitted binary variable (e.g., X∈{0,1}), Y is a received noisy observation, and P( ) is a probability density function that indicates a likelihood that Y is observed as a result of X being transmitted. Based at least in part on the above expression for an LLR, an MI for an LLR that indicates an amount of information the LLR provides about X may be computed as:

$$MI ( LLR ) = {\sum }_{k = 0}^{1} P ( Y \vert {X}_{k} = k ) {log}_{2} 2 ( P ( Y \vert {X}_{k} = k ) ) \qquad ( 4 )$$

The generation of an MI metric may be statistically averaged over multiple measurements.

A UE may then calculate an MI loss metric for one or more LLR compression levels as follows:

$$MI loss [ \% ] = \frac{( MI ( non - compressed LLRs ) - MI ( current LLR compression ) )}{MI ( non - compressed LLRs )} 100 \qquad ( 5 )$$

where the MI loss metric is generated as a percentage.

A UE may compute an MI loss metric in a variety of manners. In some aspects, the UE may compute an MI loss metric dynamically (e.g., on-demand), based at least in part on receiving a request from a network node to report the MI loss metric. Alternatively, or additionally, the network node may configure the UE to return multiple MI loss metrics using a single request, such as a request that configures the UE to compute an MI loss metric periodically or aperiodically. For example, the network node may transmit one or more parameters that configure the UE to report an MI loss metric periodically, such as by transmitting a periodicity parameter, a quantity of metrics parameter, a grant or an allocation for transmitting the MI loss metric, or any combination. Alternatively, or additionally, the network node may transmit one or more parameters for that configure the UE to transmit one or more aperiodic MI loss metrics, such as a trigger value (e.g., a threshold), a triggering condition (e.g., report on a switch to a different compression level), or both.

As an example of an aperiodic MI loss metric, the UE may autonomously switch an LLR compression levels based at least in part on a change in SNR, and the network node may configure the UE with a trigger condition to transmit an MI loss metric based at least in part on switching the LLR compression level, and the UE may compute and transmit an MI loss metric that is based at least in part on a current LLR compression level being used by the UE. The UE may also generate an MI loss metric using a current LLR compression configuration for an on-demand MI loss metric, a periodic MI loss metric, or both.

In some aspects, a communication standard or a network operator may specify multiple potential retransmission sizes (e.g., quantized potential retransmission sizes) and a linkage between each potential retransmission size and a respective potential MI loss metric or a range of potential MI loss metrics. As one example, the communication standard or network operator may specify a table, such as the table 600, that maps an MI loss metric (or a range of MI loss metrics) to a retransmission size (e.g., a quantity of parity bits in the transmission). As a first example, a first row 602 of the table 600 maps or links a first MI loss metric (shown as being 0%) to a first retransmission size (shown as being 4% of a code block size). As a second example, a second row 604 maps or links a second MI loss metric (shown as being 4%) to a second retransmission size (shown as being 12% of a code block size). As another example, the communication standard or network operator may specify one or more ranges that map to a respective retransmission size, such as by mapping a first MI loss metric that is less than or equal to 4.0% to a first potential retransmission size and mapping a second MI loss metric that is greater than 4.0% and less than or equal to 5% to a second potential retransmission size. Other examples may include the communication standard or the network operating specifying a rule, function, or equation that the network node may use to compute the potential retransmission size.

In some aspects, the mapping between an MI loss metric and a retransmission size, such as the mapping in the table 600, may link a larger retransmission size to aggressive LLR compression level, and a smaller retransmission size to a less aggressive LLR compression level. To illustrate, in the first row 602, the MI loss metric may be associated with an LLR compression level of 0 and, in the second row 604, the MI loss metric may be associated with an LLR compression level of 4 that is more aggressive than the LLR compression level of 0. Accordingly, the retransmission size mapped to the MI loss metric in the second row 604 is larger than the retransmission size that is mapped to the MI loss metric in the first row 602. While the table 600 indicates the retransmission size as a function of a code block size, other examples may include absolute values or may base the retransmission size on a different function or value.

A network node may indicate a current retransmission size that is selected using an MI loss metric (e.g., through the use of a table) to the UE. In some aspects, the network node may indicate the current retransmission size dynamically as part of a retransmission (e.g., DCI signaling or MAC CE signaling). In other aspects, the network node may indicate the current retransmission size statically as part of a configuration message or a configuration parameter (e.g., RRC signaling).

Based at least in part on selecting a retransmission size using an MI loss metric, a network node may select a larger retransmission size that includes more parity bits that compensate for heavy LLR compression (e.g., a high MI loss), and a smaller retransmission size that includes fewer parity bits for light LLR compression (e.g., a low MI loss). More particularly, an MI loss metric provides an indication of an LLR compression-decompression scheme in a universal, standardized, or generic manner such that the different UEs with different LLR compression algorithms, different LLR compression level switching algorithms, or a combination of the two may indicate a current status or current configuration of a respective LLR compression algorithm in a consistent and comparable manner. Accordingly, the network node may select and use a more optimal retransmission size relative to selecting a retransmission size without using the MI loss metric. Using a more optimal retransmission size may balance mitigating the UE requesting another retransmission with increasing spectral efficiency. Mitigating the UE requesting another retransmission and increasing spectral efficiency may reduce a data transfer latency and increase data throughput in a wireless network.

As indicated above, FIG. 6 is provided as an example. Other examples may differ from what is described with regard to FIG. 6.

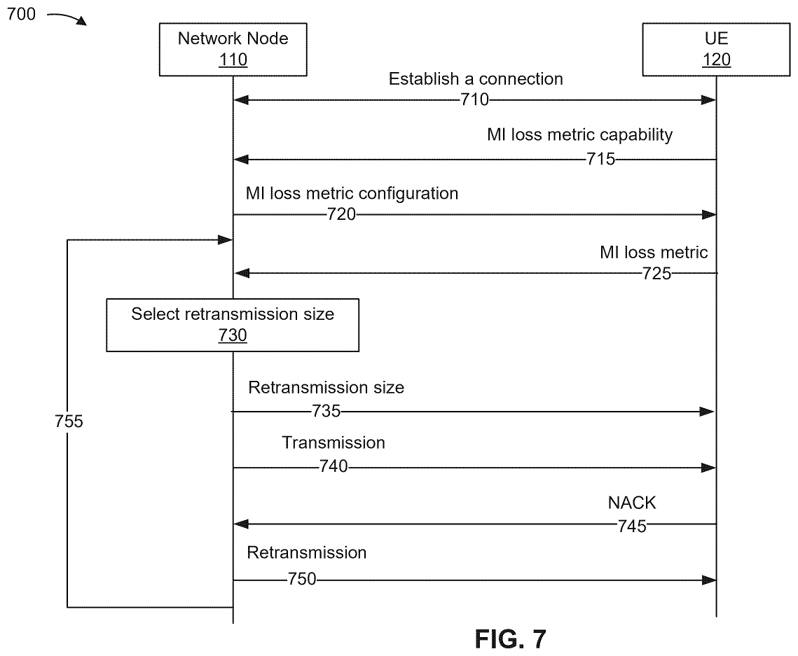

FIG. 7 is a diagram illustrating an example 700 of a wireless communication process between a network node (e.g., the network node 110) and a UE (e.g., the UE 120), in accordance with the present disclosure.

As shown by reference number 710, a network node 110 and a UE 120 may establish a connection. To illustrate, the UE 120 may power up in a cell coverage area provided by the network node 110, and the UE 120 and the network node 110 may perform one or more procedures (e.g., a random access channel (RACH) procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE 120 being tolerant of communication delays, and the network node 110 may transmit an activation of the configuration via Layer 2 signaling and/or Layer 1 signaling at a second point in time associated with the UE being less tolerant to communication delays.

As shown by reference number 715, the UE 120 may transmit, and the network node 110 may receive, an indication of an MI loss metric capability. For example, the UE 120 may indicate support for MI loss metric reporting. For clarity, FIG. 7 illustrates the UE 120 transmitting the indication of the MI loss metric capability in a separate transaction than establishing a connection with the network node 110. However, in some aspects, the UE 120 may transmit the indication of the MI loss metric capability as part of establishing a connection with the network node 110.

As shown by reference number 720, the network node 110 may transmit, and the UE 120 may receive, one or more MI loss metric configurations. Alternatively, or additionally, the network node 110 may transmit, and the UE 120 may receive, a request for an MI loss metric. For example, the network node 110 may transmit an MI loss measurement configuration that may be used by the UE 120 to configure computing an MI loss metric. As another example, the network node 110 may transmit an MI loss metric reporting configuration that indicates how to report an MI loss metric. In some aspects, an MI loss metric configuration (e.g., an MI loss measurement configuration, an MI loss metric reporting configuration, or both) may indicate a configuration for generating or reporting a periodic MI loss metric, an aperiodic MI loss metric, or an on-demand MI loss metric, such by indicating any combination of a periodicity parameter, a duration parameter (e.g., a duration for generating a periodic MI loss metric), a trigger condition for generating an MI loss metric, a threshold for the trigger condition, a quantity of MI loss metrics to return, or an allocation (e.g., a configured grant) for reporting an MI loss metric. The network node 110 may transmit an MI loss metric configuration separately from a request for an MI loss metric, or may transmit the MI loss metric configuration with the request for the MI loss metric.

As shown by reference number 725, the UE 120 may transmit, and the network node 110 may receive, an MI loss metric. To illustrate, the UE 120 may compute the MI loss metric using a current LLR compression configuration at the UE 120. Alternatively, or additionally, the UE 120 may compute the MI loss metric using an MI loss metric configuration received from the network node 110. In some aspects, the U 120 may transmit the MI loss metric based at least in part on detecting a trigger condition, or receiving a request from the network node as described with regard to reference number 725. For example, the UE 120 may transmit the MI loss metric as an aperiodic MI loss metric based at least in part on detecting that that a trigger condition has been satisfied (e.g., a switch to different LLR compression level). Alternatively, the UE 120 may transmit the MI loss metric periodically (e.g., as instructed by the network node 110).

In some aspects, the UE 120 may transmit the MI loss metric as an on-demand MI loss metric based at least in part on receiving a request from the network node 110. For instance, the network node 110 may transmit a request for an MI loss metric periodically, and the UE 120 may compute and transmit a respective MI loss metric on-demand for each periodic request from the network node. Alternatively, the network node 110 may transmit an aperiodic request for the MI loss metric, and the UE 120 may compute and transmit the MI loss metric (e.g., on-demand) for each aperiodic request. In other examples, as described above, the network node 110 may transmit a single request for an MI loss metric, where the single request configures the UE 120 to transmit multiple MI loss metrics (e.g., periodically or based on a trigger condition). The UE 120 may generate a MI loss metric in a similar manner as described with regard to FIG. 6 and may use a current LLR compression configuration at the UE 120.

As shown by reference number 730, the network node 110 may select a retransmission size. To illustrate, as described with regard to FIG. 6, the network node 110 may select the retransmission size from multiple potential retransmission sizes that are each linked to a respective MI loss metric, such as by accessing a table that links the potential retransmission sizes to MI loss metrics (or range of MI loss metrics) or computing a retransmission size using an equation. The table or equation may be specified by a communication standard, a network operator, or both.

As shown by reference number 735, the network node 110 may transmit, and the UE 120 may receive, an indication of a retransmission size. The network node 110 may indicate the retransmission size in Layer 1 signaling, Layer 2 signaling, Layer 3 signaling, or any combination thereof. In some aspects, the network node 110 may transmit the retransmission size as part of a configuration message that configures a HARQ process. In other aspects, the network node 110 may transmit an indication of the retransmission size in a retransmission, such as the retransmission described with regard to reference number 750. Accordingly, for clarity, FIG. 7 illustrates the network node 110 transmitting the retransmission size separately from transmitting a retransmission, but in some aspects, the retransmission size may be transmitted with the retransmission message.

As shown by reference number 740, the network node 110 may transmit, and the UE 120 may receive, a transmission. In some aspects, the transmission may be based at least in part on an MIRS-based HARQ process.

As shown by reference number 745, the UE 120 may transmit, and the network node 110 may receive, a request for a retransmission (shown by FIG. 7 as a NACK). For instance, the UE 120 may transmit the request for the retransmission based at least in part on failing to decode the transmission successfully. In some aspects, the decoding may be based at least in part on soft information in the form of LLRs, and the UE 120 may perform LLR compression to store the LLRs.

As shown by reference number 750, the network node 110 may transmit, and the UE 120 may receive, a retransmission that is based at least in part on the retransmission size selected by the network node 110 as described with regard to reference number 730. In some aspects, the retransmission may include a quantity of parity bits that is based at least in part on the retransmission size. That is, the retransmission may be part of an MIRS-based HARQ process and may include one or more parity bits that were not included in the original transmission that is associated with the retransmission request (e.g., the transmission described with regard to reference number 740). Alternatively, or additionally, the retransmission may not include a payload that was included in the original transmission. Based at least in part on receiving the retransmission, the UE 120 may decompress the stored LLRs and combine the decompressed LLRs with the parity bits in the retransmission to generate updated soft information (e.g., updated LLRs). The UE 120 may then use the updated soft information to attempt decoding.

As shown by reference number 755, the network node 110 and the UE 120 may iteratively perform one or more steps of the process 700. To illustrate, the MI loss metric transmitted by the UE 120 as described with regard to reference number 725 may be a first MI loss metric, and the retransmission size selected by the network node 110 as described with regard to reference number 730 may be a first retransmission size. The UE 120 may subsequently transmit, and the network node 110 may subsequently receive, a second MI loss metric (e.g., based at least in part on switching LLR compression levels) such that the network node 110 selects a second retransmission size and transmits an indication of the second retransmission size to the UE 120. The network node 110 and the UE 120 may perform an MIRS-based HARQ process using the second retransmission size.

Using an MI loss metric to select a retransmission size may enable a network node may select a larger retransmission size that includes more parity bits that compensate for heavy LLR compression (e.g., a high MI loss), and a smaller retransmission size that includes fewer parity bits for light LLR compression (e.g., a low MI loss). More particularly, an MI loss metric provides an indication of an LLR compression-decompression scheme in a universal, standardized, or generic manner such that the different UEs with different LLR compression algorithms, different LLR compression level switching algorithms, or a combination of the two may indicate a current status or current configuration of a respective LLR compression algorithm in a consistent and comparable manner. Accordingly, the network node may select and use a more optimal retransmission size relative to selecting a retransmission size without using the MI loss metric. Using a more optimal retransmission size may balance mitigating the UE requesting another retransmission with increasing spectral efficiency. Mitigating the UE requesting another retransmission and increasing spectral efficiency may reduce a data transfer latency and increase data throughput in a wireless network.

As indicated above, FIG. 7 is provided as an example. Other examples may differ from what is described with regard to FIG. 7.

FIG. 8 is a diagram illustrating an example process 800 performed, for example, at a network node or an apparatus of a network node. Example process 800 is an example where the apparatus or the network node (e.g., network node 110) performs operations associated with a retransmission size based on an MI loss metric.

As shown in FIG. 8, in some aspects, process 800 may include receiving a first indication of an MI loss metric that is specific to a UE (block 810). For example, the network node (e.g., using reception component 1002 or communication manager 1006, depicted in FIG. 10) may receive a first indication of an MI loss metric that is specific to a UE, as described above.

As further shown in FIG. 8, in some aspects, process 800 may include transmitting a second indication of a retransmission size that is based at least in part on the MI loss metric (block 820). For example, the network node (e.g., using transmission component 1004 or communication manager 1006, depicted in FIG. 10) may transmit a second indication of a retransmission size that is based at least in part on the MI loss metric, as described above.

Process 800 may include additional aspects, such as any single aspect or any combination of aspects described below or in connection with one or more other processes described elsewhere herein.

In a first aspect, process 800 includes transmitting a request for the MI loss metric, and receiving the first indication of the MI loss metric is based at least in part on the request.

In a second aspect, transmitting the request for the MI loss metric includes transmitting the request periodically.

In a third aspect, transmitting the request for the MI loss metric includes transmitting the request aperiodically.

In a fourth aspect, process 800 includes selecting the retransmission size from multiple potential retransmission sizes, each potential retransmission size of the multiple potential retransmission sizes linked to a respective potential MI loss metric.

In a fifth aspect, a communication standard specifies each potential retransmission size and the linked respective potential MI loss metric.

In a sixth aspect, a network operator specifies each potential retransmission size and the linked respective potential MI loss metric.

In a seventh aspect, process 800 includes receiving a retransmission request that is associated with the UE, and transmitting a retransmission using the retransmission size.

In an eighth aspect, the retransmission includes a MIRS retransmission that includes one or more parity bits not included in an original transmission associated with the retransmission request.

In a ninth aspect, the original transmission includes a payload, and the retransmission does not include the payload included in the original transmission.

In a tenth aspect, the MI loss metric is a first MI loss metric, the retransmission size is a first retransmission size, and process 800includes receiving a third indication of a second MI loss metric that is specific to the UE, selecting a second retransmission size, and transmitting a fourth indication of the second retransmission size.

In an eleventh aspect, the MI loss metric is based at least in part on a log-likelihood-ratio compression level.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE. Example process 900 is an example where the apparatus or the UE (e.g., UE 120) performs operations associated with a retransmission size based an MI loss metric.

As shown in FIG. 9, in some aspects, process 900 may include transmitting a first indication of an MI loss metric that is specific to the UE (block 910). For example, the UE (e.g., using transmission component 1104 or communication manager 1106, depicted in FIG. 11) may transmit a first indication of an MI loss metric that is specific to the UE, as described above.

As further shown in FIG. 9, in some aspects, process 900 may include receiving a second indication of a retransmission size that is based at least in part on the MI loss metric (block 920). For example, the UE (e.g., using reception component 1102 or communication manager 1106, depicted in FIG. 11) may receive a second indication of a retransmission size that is based at least in part on the MI loss metric, as described above.

Process 900 may include additional aspects, such as any single aspect or any combination of aspects described below or in connection with one or more other processes described elsewhere herein.

In a first aspect, process 900 includes receiving a request for the MI loss metric, and transmitting the first indication of the MI loss metric is based at least in part on the request.

In a second aspect, receiving the request for the MI loss metric includes receiving the request periodically.

In a third aspect, receiving the request for the MI loss metric includes receiving the request aperiodically.

In a fourth aspect, process 900 includes transmitting a retransmission request, and receiving a retransmission that is based at least in part on the retransmission size.

In a fifth aspect, the retransmission includes a MIRS retransmission that includes one or more parity bits not included in an original transmission associated with the retransmission request.

In a sixth aspect, the original transmission includes a payload, and the retransmission does not include the payload included in the original transmission.

In a seventh aspect, the MI loss metric is a first MI loss metric, the retransmission size is a first retransmission size, and process 900 includes transmitting a third indication of a second MI loss metric, and receiving a fourth indication of a second retransmission size.

In an eighth aspect, the MI loss metric is based at least in part on a log-likelihood-ratio compression level.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 4-7. Additionally, or alternatively, the apparatus 1000 may be configured to perform one or more processes described herein, such as process 800 of FIG. 8, or a combination thereof. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The reception component 1002 may receive a first indication of an MI loss metric that is specific to a UE. The transmission component 1004 may transmit a second indication of a retransmission size that is based at least in part on the MI loss metric. Alternatively, or additionally, the transmission component 1004 may transmit a request for the MI loss metric and receiving the first indication of the MI loss metric is based at least in part on the request.

The communication manager 1006 may select the retransmission size from multiple potential retransmission sizes, each potential retransmission size of the multiple potential retransmission sizes linked to a respective potential MI loss metric. In some aspects, the reception component 1002 may receive a retransmission request that is associated with the UE. The transmission component 1004 may transmit a retransmission using the retransmission size.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 4-7. Additionally, or alternatively, the apparatus 1100 may be configured to perform one or more processes described herein, such as process 900 of FIG. 9, or a combination thereof. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The transmission component 1104 may transmit a first indication of a mutual information (MI) loss metric that is specific to the UE. The reception component 1102 may receive a second indication of a retransmission size that is based at least in part on the MI loss metric. Alternatively, or additionally, the reception component 1102 may receive a request for the MI loss metric and transmitting the first indication of the MI loss metric is based at least in part on the request.

The transmission component 1104 may transmit a retransmission request. In some aspects, the reception component 1102 may receive a retransmission that is based at least in part on the retransmission size.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a network node, comprising: receiving a first indication of a mutual information (MI) loss metric that is specific to a user equipment (UE); and transmitting a second indication of a retransmission size that is based at least in part on the MI loss metric.
Aspect 2: The method of Aspect 1, further comprising: transmitting a request for the MI loss metric, wherein receiving the first indication of the MI loss metric is based at least in part on the request.
Aspect 3: The method of Aspect 2, wherein transmitting the request for the MI loss metric comprises: transmitting the request periodically.
Aspect 4: The method of Aspect 2, wherein transmitting the request for the MI loss metric comprises: transmitting the request aperiodically.
Aspect 5: The method of any of Aspects 1-4, further comprising: selecting the retransmission size from multiple potential retransmission sizes, each potential retransmission size of the multiple potential retransmission sizes linked to a respective potential MI loss metric.
Aspect 6: The method of Aspect 5, wherein a communication standard specifies each potential retransmission size and the linked respective potential MI loss metric.
Aspect 7: The method of Aspect 5, wherein a network operator specifies each potential retransmission size and the linked respective potential MI loss metric.
Aspect 8: The method of any of Aspects 1-7, further comprising: receiving a retransmission request that is associated with the UE; and transmitting a retransmission using the retransmission size.
Aspect 9: The method of Aspect 8, wherein the retransmission comprises a multi-incremental redundancy scheme (MIRS) retransmission that includes one or more parity bits not included in an original transmission associated with the retransmission request.
Aspect 10: The method of Aspect 9, wherein the original transmission includes a payload, and wherein the retransmission does not include the payload included in the original transmission.
Aspect 11: The method of any of Aspects 1-10, wherein the MI loss metric is a first MI loss metric, wherein the retransmission size is a first retransmission size, and wherein the method further comprises: receiving a third indication of a second MI loss metric that is specific to the UE; selecting a second retransmission size; and transmitting a fourth indication of the second retransmission size.
Aspect 12: The method of any of Aspects 1-11, wherein the MI loss metric is based at least in part on a log-likelihood-ratio compression level.
Aspect 13: A method of wireless communication performed by a user equipment (UE), comprising: transmitting a first indication of a mutual information (MI) loss metric that is specific to the UE; and receiving a second indication of a retransmission size that is based at least in part on the MI loss metric.
Aspect 14: The method of Aspect 13, further comprising: receiving a request for the MI loss metric, wherein transmitting the first indication of the MI loss metric is based at least in part on the request.
Aspect 15: The method of Aspect 14, wherein receiving the request for the MI loss metric comprises: receiving the request periodically.
Aspect 16: The method of Aspect 14, wherein receiving the request for the MI loss metric comprises: receiving the request aperiodically.
Aspect 17: The method of any of Aspects 13-16, further comprising: transmitting a retransmission request; and receiving a retransmission that is based at least in part on the retransmission size.
Aspect 18: The method of Aspect 17, wherein the retransmission comprises a multi-incremental redundancy scheme (MIRS) retransmission that includes one or more parity bits not included in an original transmission associated with the retransmission request.
Aspect 19: The method of Aspect 18, wherein the original transmission includes a payload, and wherein the retransmission does not include the payload included in the original transmission.
Aspect 20: The method of any of Aspects 13-19, wherein the MI loss metric is a first MI loss metric, wherein the retransmission size is a first retransmission size, and wherein the method further comprises: transmitting a third indication of a second MI loss metric; and receiving a fourth indication of a second retransmission size.
Aspect 21: The method of any of Aspects 13-20, wherein the MI loss metric is based at least in part on a log-likelihood-ratio compression level.
Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-12.
Aspect 23: An apparatus for wireless communication at a device, the apparatus comprising one or more memories and one or more processors coupled to the one or more memories, the one or more processors configured to cause the device to perform the method of one or more of Aspects 1-12.
Aspect 24: An apparatus for wireless communication, the apparatus comprising at least one means for performing the method of one or more of Aspects 1-12.
Aspect 25: A non-transitory computer-readable medium storing code for wireless communication, the code comprising instructions executable by one or more processors to perform the method of one or more of Aspects 1-12.
Aspect 26: A non-transitory computer-readable medium storing a set of instructions for wireless communication, the set of instructions comprising one or more instructions that, when executed by one or more processors of a device, cause the device to perform the method of one or more of Aspects 1-12.
Aspect 27: A device for wireless communication, the device comprising a processing system that includes one or more processors and one or more memories coupled with the one or more processors, the processing system configured to cause the device to perform the method of one or more of Aspects 1-12.
Aspect 28: An apparatus for wireless communication at a device, the apparatus comprising one or more memories and one or more processors coupled to the one or more memories, the one or more processors individually or collectively configured to cause the device to perform the method of one or more of Aspects 1-12.
Aspect 29: A device comprising a processing system that includes one or more processors and one or more code-storing memories coupled with the one or more processors, the processing system configured to cause the device to perform the method of one or more of Aspects 1-12.
Aspect 30: A device comprising a processing system that includes processor circuitry and code-storing memory circuitry, the processing system configured to cause the device to perform the method of one or more of Aspects 1-12.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 13-21.
Aspect 32: An apparatus for wireless communication at a device, the apparatus comprising one or more memories and one or more processors coupled to the one or more memories, the one or more processors configured to cause the device to perform the method of one or more of Aspects 13-21.
Aspect 33: An apparatus for wireless communication, the apparatus comprising at least one means for performing the method of one or more of Aspects 13-21.
Aspect 34: A non-transitory computer-readable medium storing code for wireless communication, the code comprising instructions executable by one or more processors to perform the method of one or more of Aspects 13-21.
Aspect 35: A non-transitory computer-readable medium storing a set of instructions for wireless communication, the set of instructions comprising one or more instructions that, when executed by one or more processors of a device, cause the device to perform the method of one or more of Aspects 13-21.
Aspect 36: A device for wireless communication, the device comprising a processing system that includes one or more processors and one or more memories coupled with the one or more processors, the processing system configured to cause the device to perform the method of one or more of Aspects 13-21.
Aspect 37: An apparatus for wireless communication at a device, the apparatus comprising one or more memories and one or more processors coupled to the one or more memories, the one or more processors individually or collectively configured to cause the device to perform the method of one or more of Aspects 13-21.
Aspect 38: A device comprising a processing system that includes one or more processors and one or more code-storing memories coupled with the one or more processors, the processing system configured to cause the device to perform the method of one or more of Aspects 13-21.
Aspect 39: A device comprising a processing system that includes processor circuitry and code-storing memory circuitry, the processing system configured to cause the device to perform the method of one or more of Aspects 13-21.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network node, comprising:
a processing system that includes one or more processors and one or more code-storing memories coupled with the one or more processors, the processing system configured to cause the network node to:
receive a first indication of a mutual information (MI) loss metric that is specific to a user equipment (UE); and
transmit a second indication of a retransmission size that is based at least in part on the MI loss metric.

2. The network node of claim 1, wherein the processing system is configured to cause the network node to:
transmit a request for the MI loss metric,
wherein the processing system, to cause the network node to receive the first indication, is configured to cause the network node to:
receive the first indication of the MI loss metric based at least in part on the request.

3. The network node of claim 2, wherein the processing system, to cause the network node to transmit the request for the MI loss metric, is configured to cause the network node to:
transmit the request periodically.

4. The network node of claim 2, wherein the processing system, to cause the network node to transmit the request for the MI loss metric, is configured to cause the network node to:
transmit the request aperiodically.

5. The network node of claim 1, wherein the processing system is configured to cause the network node to:
select the retransmission size from multiple potential retransmission sizes, each potential retransmission size of the multiple potential retransmission sizes linked to a respective potential MI loss metric.

6. The network node of claim 1, wherein the processing system is configured to cause the network node to:
receive a retransmission request that is associated with the UE; and
transmit a retransmission using the retransmission size.

7. The network node of claim 6, wherein the retransmission comprises a multi-incremental redundancy scheme (MIRS) retransmission that includes one or more parity bits not included in an original transmission associated with the retransmission request.

8. The network node of claim 1, wherein the MI loss metric is a first MI loss metric,
wherein the retransmission size is a first retransmission size, and
wherein the processing system is configured to cause the network node to:
receive a third indication of a second MI loss metric that is specific to the UE;
select a second retransmission size; and
transmit a fourth indication of the second retransmission size.

9. The network node of claim 1, wherein the MI loss metric is based at least in part on a log-likelihood-ratio compression level.

10. A method of wireless communication performed by a network node, comprising:
receiving a first indication of a mutual information (MI) loss metric that is specific to a user equipment (UE); and
transmitting a second indication of a retransmission size that is based at least in part on the MI loss metric.

11. The method of claim 10, further comprising:
transmitting a request for the MI loss metric,
wherein receiving the first indication of the MI loss metric is based at least in part on the request.

12. The method of claim 10, further comprising:
selecting the retransmission size from multiple potential retransmission sizes, each potential retransmission size of the multiple potential retransmission sizes linked to a respective potential MI loss metric.

13. The method of claim 10, further comprising:
receiving a retransmission request that is associated with the UE; and
transmitting a retransmission using the retransmission size.

14. The method of claim 13, wherein the retransmission comprises a multi-incremental redundancy scheme (MIRS) retransmission that includes one or more parity bits not included in an original transmission associated with the retransmission request.

15. The method of claim 10, wherein the MI loss metric is a first MI loss metric,
wherein the retransmission size is a first retransmission size, and
wherein the method further comprises:
receiving a third indication of a second MI loss metric that is specific to the UE;
selecting a second retransmission size; and
transmitting a fourth indication of the second retransmission size.

16. A non-transitory computer-readable medium storing a set of instructions for wireless communication, the set of instructions comprising:
one or more instructions that, when executed by one or more processors of a network node, cause the network node to:
receive a first indication of a mutual information (MI) loss metric that is specific to a user equipment (UE); and
transmit a second indication of a retransmission size that is based at least in part on the MI loss metric.

17. The non-transitory computer-readable medium of claim 16, wherein the one or more instructions further cause the network node to:
transmit a request for the MI loss metric,
wherein receiving the first indication of the MI loss metric is based at least in part on the request.

18. The non-transitory computer-readable medium of claim 16, wherein the one or more instructions further cause the network node to:
select the retransmission size from multiple potential retransmission sizes, each potential retransmission size of the multiple potential retransmission sizes linked to a respective potential MI loss metric.

19. The non-transitory computer-readable medium of claim 16, wherein the one or more instructions further cause the network node to:
receive a retransmission request that is associated with the UE; and
transmit a retransmission using the retransmission size.

20. The non-transitory computer-readable medium of claim 16, wherein the MI loss metric is a first MI loss metric,
wherein the retransmission size is a first retransmission size, and
wherein the one or more instructions further cause the network node to:
receive a third indication of a second MI loss metric that is specific to the UE;
select a second retransmission size; and
transmit a fourth indication of the second retransmission size.
